(19) United States
(12) Patent Application Publication
(10) Pub. No.: US 2015/0232089 A1
(43) Pub. Date: Aug. 20, 2015

(54) APPARATUS AND PROGRAM FOR SETTING ASSISTANCE REGION

(71) Applicant: DENSO CORPORATION, Kariya-city (JP)

(72) Inventors: HIROAKI NIINO, Toyota-shi (JP); MASAYOSHI OOISHI, Anjo-shi (JP); YOSUKE HATTORI, Aichi-ken (JP); HIDESHI IZUHARA, Kasugai-shi (JP); HIROKI TOMABECHI, Aichi-ken (JP)

(21) Appl. No.: 14/622,986

(22) Filed: Feb. 16, 2015

(30) Foreign Application Priority Data
Feb. 17, 2014 (JP) 2014-027640

(51) Int. Cl. B60W 30/08

(52) U.S. Cl. CPC B60W 30/08

(57) ABSTRACT

An apparatus is configured for setting an assistance region for assisting a driver's recognition of a circumstance around a vehicle. The assistance region is indicative of at least one of: an imaging region of a device for picking up an image of the imaging region, and a particular image-processing region in the picked-up image. In the apparatus, a first unit estimates, based on a travelling condition of the vehicle, a turning parameter indicative of how the vehicle is turning or is about to turn. The turning parameter includes a turning course of the vehicle. A second unit sets the assistance region to an outside of the turning course of the vehicle.

### CROSS REFERENCE TO RELATED APPLICATION

This application is based on and claims the benefit of priority from Japanese Patent Application No. 2014-027640, filed on Feb. 17, 2014, which is incorporated in its entirety herein by reference.

### TECHNICAL FIELD

The present disclosure relates to apparatuses and programs for setting an assistance region for a driver's recognition of something around a vehicle. The assistance region represents at least one of an imaging region of a camera device for picking up images of the imaging region, and an image-processing region in each of the picked-up images.

### BACKGROUND

A first example of these apparatuses is disclosed in Japanese Patent Application Publication No. 2002-312898, which will be referred to as a first patent document.

The apparatus disclosed in the first patent document is installed in a vehicle. The apparatus is designed to set the target imaging range of an infrared camera device for detecting heat-emitting objects, such as pedestrians.

However, the apparatus disclosed in the first patent document uses an expensive infrared camera device for detecting pedestrians, resulting in an increase of the manufacturing cost of the apparatus.

A second example of these apparatuses is disclosed in Japanese Patent Application Publication No. 2001-180404, which will be referred to as a second patent document.

The apparatus disclosed in the second patent document is installed in a vehicle. When the vehicle is turning, the apparatus is designed to set an imaging region, i.e. an imaging range, of a camera device to a region located at an inner side of the turning vehicle. This aims to prevent a stationary object from being erroneously detected as an incoming object even if the vehicle is turning.

### SUMMARY

However, the apparatus disclosed in the second patent document may set the imaging range to the region located at the inner side of the curve travelled by a turning vehicle; the region is expected to be watched by the driver of the turning vehicle. It may be therefore difficult for the driver to recognize the circumstances of another region located at the outer side of the curve travelled by the turning vehicle; the other region located at the outer side of the turning vehicle is likely to be expected to be overlooked by the driver of the turning vehicle.

In view the circumstances set forth above, one aspect of the present disclosure seeks to provide apparatuses and computer programs for setting an assistance region for a driver's recognition of a circumstance around a vehicle, the assistance region being indicative of at least one of: an imaging region of a device for picking up an image of the imaging region; and a particular image-processing region in the picked-up image. The apparatuses and computer programs are capable of addressing the problems set forth above.

Specifically, an alternative aspect of the present disclosure aims to provide such apparatuses and programs, each of which enables a driver of the vehicle to easily recognize the circumstance of a region located outside a turning course of the vehicle; the region is expected to be overlooked by the driver of the turning vehicle.

According to a first exemplary aspect of the present disclosure, there is provided an apparatus for setting an assistance region for assisting a driver's recognition of a circumstance around a vehicle. The assistance region is indicative of at least one of: an imaging region of a device for picking up an image of the imaging region, and a particular image-processing region in the picked-up image. The apparatus includes a memory device, and a controller communicable to the memory device. The controller is configured to estimate, based on a travelling condition of the vehicle, a turning parameter indicative of how the vehicle is turning or is about to turn, the turning parameter including a turning course of the vehicle. The controller is also configured to set the assistance region to an outside of the turning course of the vehicle.

According to a second exemplary aspect of the present disclosure, there is provided a computer program product for an apparatus that sets an assistance region for assisting a driver's recognition of a circumstance around a vehicle. The assistance region is indicative of at least one of: an imaging region of a device for picking up an image of the imaging region, and a particular image-processing region in the picked-up image. The computer program product includes a non-transitory computer-readable storage medium; and a set of computer program instructions embedded in the computer-readable storage medium. The instructions cause a computer to carry out

(1) A first step of estimating, based on a travelling condition of the vehicle, a turning parameter indicative of how the vehicle is turning or is about to turn, the turning parameter including a turning course of the vehicle

(2) A second step of setting the assistance region to an outside of the turning course of the vehicle.

Each of the apparatus and computer program product according to the first and second exemplary aspects of the present disclosure makes it possible to

1. Complementarily pick up images of a region located outside the turning course of the vehicle; the region is expected to be overlooked by the driver of the vehicle, or

2. Perform image processing of a portion of a picked-up image; the portion matches with the region located outside the vehicle V with a higher priority as compared with the remaining portion of the picked-up image.

This makes it possible for the driver of the vehicle to easily recognize the circumstances of the region located outside the turning course of the vehicle, or to immediately recognize at least one obstacle existing in the portion of the picked-up image.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition, various aspects of the present disclosure can combine one or more feature of other embodiments where applicable. The descriptions of features, and/or advantages of particular embodiments should not be construed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the overall structure of a drive assist system installed in a vehicle according to the first embodiment of the present disclosure;

FIG. 2 is a flowchart schematically illustrating an assistance region setting routine carried out by a controller of the drive assist system illustrated in FIG. 1;

FIG. 3 is a flowchart schematically illustrating a subroutine called by the assistance region setting routine;

FIG. 4 is a view schematically illustrating various angular parameters used by the drive assist system according to the first embodiment;

FIG. 5 is a view schematically illustrating how to estimate a turning course and a turning angle of the vehicle according to the first embodiment;

FIG. 6 is a graph schematically illustrating how an optical-axis adjustment angle changes as the turning angle of the vehicle positively changes according to the first embodiment

FIG. 7 is a block diagram schematically illustrating an example of the overall structure of a drive assist system installed in a vehicle according to the second embodiment of the present disclosure;

FIG. 8 is a flowchart schematically illustrating an assistance region setting routine carried out by the controller of the drive assist system illustrated in FIG. 7; and

FIG. 9 is a view schematically illustrating a normal image-processing region and an outside image-processing region located on an image picked up by a camera of the drive assist system according to the second embodiment.

### DETAILED DESCRIPTION OF EMBODIMENT

Specific embodiments of the present disclosure will be described hereinafter with reference to the accompanying drawings. In the embodiments, like parts between the embodiments, to which like reference characters are assigned, are omitted or simplified to avoid redundant description.

### First Embodiment

A drive assist system, to which an apparatus according to the first embodiment is applied, is installed in a vehicle, such as a passenger vehicle, V. The drive assist system 1 has functions of assisting a driver's driving of the vehicle V based on picked up images around the vehicle V.

Particularly, the drive assist system 1 is operative to determine whether there is at least one object, such as another vehicle or a pedestrian, located at a region that a driver of the vehicle is likely to overlook, such as a region located outside a turning course of the vehicle V. The drive assist system 1 is also operative to perform, based on the results of the determination, at least one of a task of visibly and/or audibly generating a warning, and a task of controlling the operating conditions of the vehicle V.

Note that the sentence “a vehicle is turning”, the phrase “turning of a vehicle, or another similar sentence or phrase includes

(1) The vehicle is turning from one road to another road

(2) The vehicle is travelling on a curve

(3) any situation where the vehicle is not driving in a straight line.

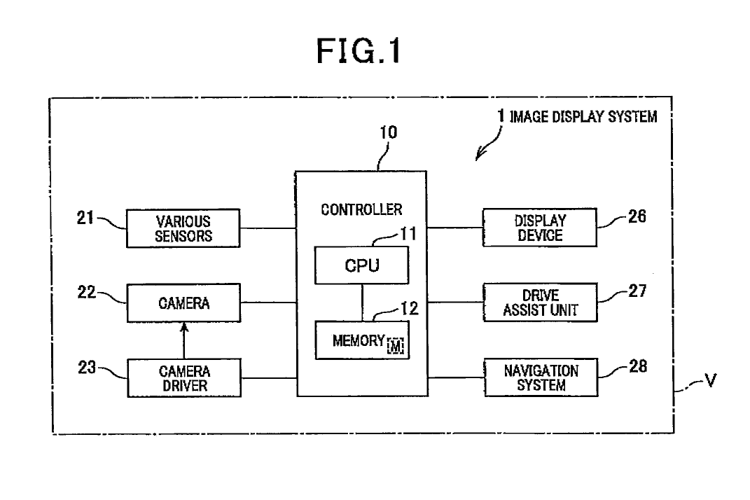

Referring to FIG. 1, the drive assist system 1 includes a controller 10, various sensors 21, a camera 22, a camera driver 23, a display device 26, and a drive assist unit 27.

The various sensors 21 include, for example, sensors for measuring parameters associated with the travelling conditions of the vehicle V, such as a vehicle speed sensor, a steering-angle sensor, a brake sensor, an accelerator position sensor, an acceleration sensor, and a yaw-rate sensor.

The vehicle speed sensor is operative to measure the speed of the vehicle V, and operative to output, to the controller 10, a vehicle-speed signal indicative of the measured speed of the vehicle V.

The steering-angle sensor is operative to output, to the controller 10, a signal indicative of a driver's operated steering angle of a steering wheel of the vehicle V.

The brake sensor is operative to, for example, detect a driver's operation amount of a brake pedal of the vehicle V, and output, to the controller 10, a brake signal indicative of the driver's operated quantity of the brake pedal.

The accelerator position sensor is operative to detect a position of a throttle valve for controlling the amount of air entering an internal combustion engine of the vehicle V. That is, the position of the throttle valve represents how the throttle valve is opened. The accelerator position sensor is operative to output an accelerator-position signal indicative of the detected position of the throttle valve as an accelerator position to the controller 10.

The acceleration sensor is operative to measure lateral acceleration Gy of the vehicle V in the vehicle width direction, and output, to the controller 10, a signal indicative of the measured lateral acceleration Gy of the vehicle V.

The yaw-rate sensor is operative to output, to the controller 10, a signal indicative of an angular velocity around a vertical axis of the vehicle V as a yaw rate of the vehicle V.

That is, the signals sent from the sensors 21 including the vehicle speed sensor, steering-angle sensor, brake sensor, accelerator position sensor, acceleration sensor, and yaw-rate sensor are received by the controller 10 as travelling-condition signals indicative of the parameters associated with the travelling conditions of the vehicle V; the parameters will be referred to as the travelling-condition parameters.

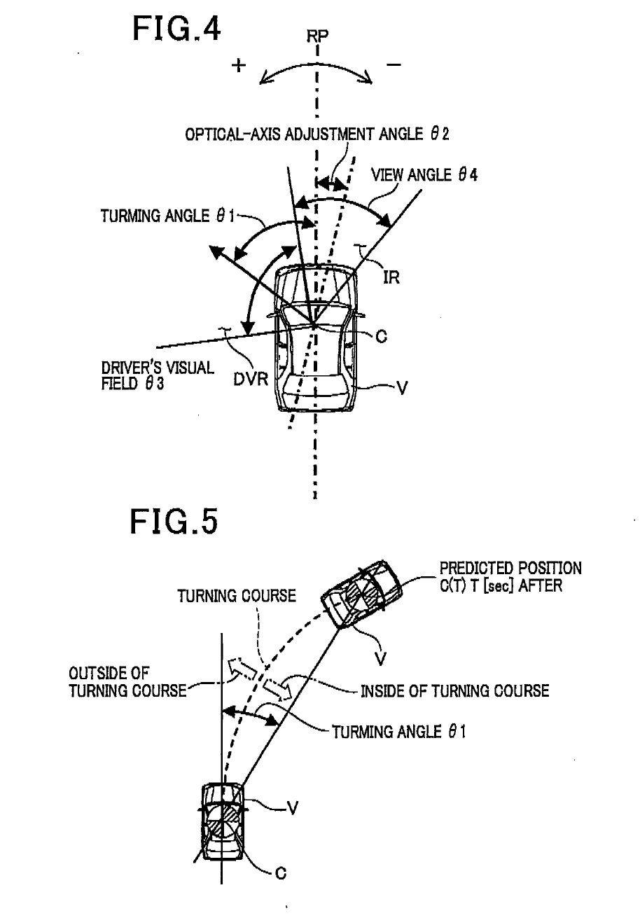

The camera 22 is attached to, for example, the front center of the vehicle V. The camera 22 has, as its imaging region IR, i.e. imaging range, a sector region in a horizontal direction, i.e. the width direction of the vehicle V ahead of the vehicle V. Specifically, the sector imaging region IR has a symmetric shape relative to the optical axis, i.e. imaging axis, OA (see FIG. 4), extends toward the front side of the vehicle V, and has a predetermined vertical width in the height direction of the vehicle V.

Specifically, the camera 22 is operative to successively pick up images, i.e. frame images, of the imaging region IR, and successively send the picked-up images as digital images, i.e. digital image data, to the controller 10.

Referring to FIG. 4, the camera driver 23 is designed as an actuator mechanically linked to the camera 22. Specifically, the camera driver 23 is configured to adjust, under control of the controller 10, a minimum angle θ2 of the optical axis OA relative to a reference plane RP. The reference plane RP passes through a center C of gravity of the vehicle V, and extends both in the longitudinal direction of the vehicle V while the vehicle V is travelling straight and in the height direction of the vehicle V. The minimum angle θ2 of the optical axis OA of the camera 22 will be referred to as an optical-axis adjustment angle θ2 hereinafter.

The display device 26 is operative to successively display images generated by the controller 10. A commercially available display for vehicles can be used as the display device 26.

The drive assist unit 27 is operative to obtain the picked-up images as digital images, i.e. digital image data, from the controller 10, and perform, under control of the controller 10, a task for assisting drive of the vehicle V based on the picked-up images.

Specifically, the drive assist unit 27 performs image processing, i.e. known object-recognition processing, of at least part of each of the picked-up images; the at least part of each of the picked-up images is contained in a changeable image-processing region. In the first embodiment, the image-processing region is, for example, previously set to have a size smaller than the imaging region IR and be located at a substantially center portion of the imaging region IR of the camera 22.

For example, when recognizing at least one obstacle, such as another vehicle and a pedestrian, in a picked-up image as a result of the image processing, the drive assist unit 27 performs

(1) The task for assisting drive of the vehicle V. The task includes, for example, controlling, i.e. assisting, the accelerator position of the vehicle V, the degree/amount of the brake pedal of the vehicle V, and the steering angle of the steering wheel of the vehicle V

(2) Visibly and/or audibly generating a warning to the driver of the vehicle V.

The vehicle V can be provided with a navigation system 28 communicably connected to the controller 10. The navigation system 28 stores therein map information about where the vehicle V can travel. The navigation system 28 is capable of detecting the current location of the vehicle V, and determining and displaying, on a map around the current position of the vehicle V displayed on a monitor thereof, the best route to a specified destination from the current location of the vehicle V.

The controller 10 is mainly comprised of a well-known microcomputer consisting of, for example, a CPU 11 and a memory unit 12 including at least one of a ROM and a RAM, which are communicably connected to each other. Particularly, the memory unit 12 includes a non-volatile memory that does not need power to retain data.

The CPU 11 performs various routines, i.e. various sets of instructions, including an assistance region setting routine, stored in the memory device 12.

Next, operations of the drive assist system 1 according to the first embodiment will be described hereinafter.

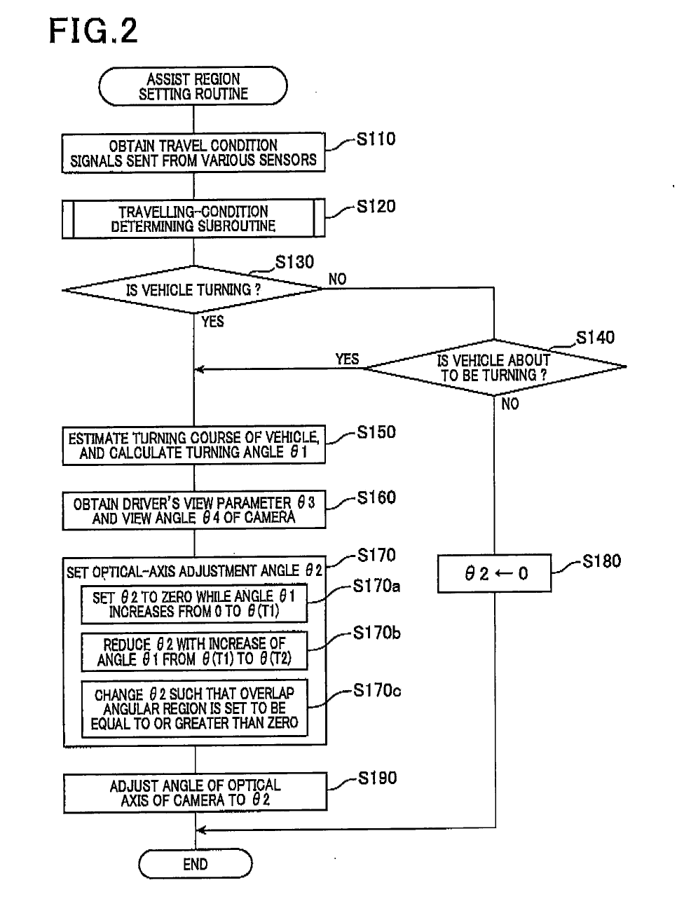

For example, when the vehicle V is powered on, i.e. the ignition of the vehicle V is switched on, the CPU 11 of the controller 10 starts the assistance region setting routine, and performs the assistance region setting routine every predetermined cycle (see FIG. 2).

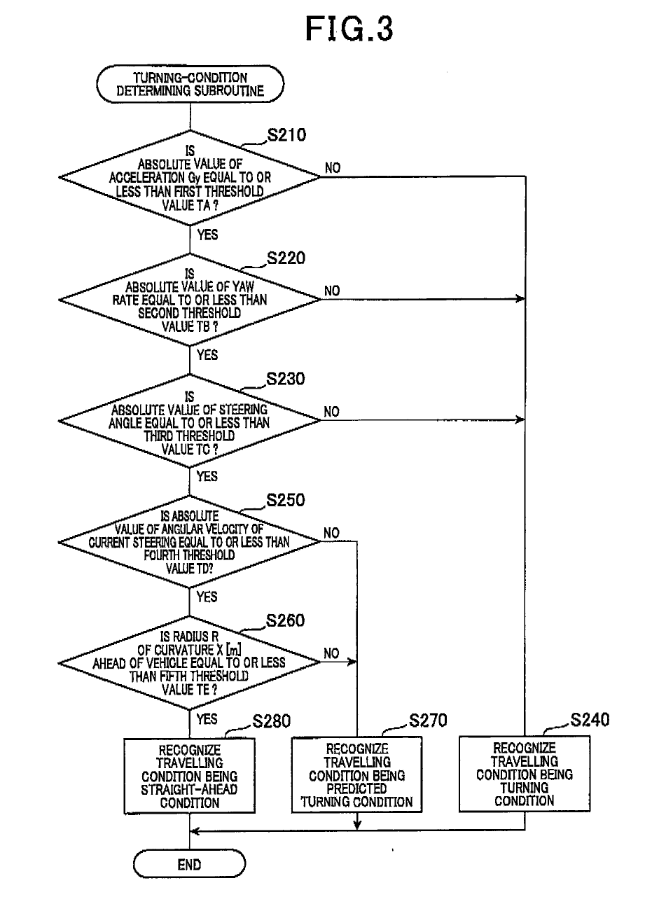

When starting the assistance region setting routine, the CPU 11 receives the travelling condition signals sent from the various sensors 21 in step S110. Then, the CPU 11 calls a travelling-condition determining subroutine for determining, based on the travelling-condition signals, whether the vehicle V is travelling straight, is turning, or is about to turn in step S120. An example of the execution procedure of the travelling-condition determining subroutine will be described in FIG. 3.

When calling the travelling-condition determining subroutine, the CPU 11 obtains

(1) An absolute value of the current lateral acceleration Gy of the vehicle V in the vehicle width direction based on the travelling condition signal sent from the acceleration sensor

(2) An absolute value of the current yaw rate of the vehicle V based on the travelling condition signal sent from the yaw-rate sensor

(3) An absolute value of the current driver's steering angle of the steering wheel indicative of a total steering angle of the vehicle V based on the travelling condition signal sent from the steering-angle sensor in step S200.

Then, the CPU 11 determines whether

1. The absolute value of the current lateral acceleration Gy is equal to or less than a predetermined first threshold value TA in step S210

2. The absolute value of the current yaw rate is equal to or less than a predetermined second threshold value TB in step S220

3. The absolute value of the current driver's steering angle of the steering wheel is equal to or less than a predetermined third threshold value in step S230.

When at least one of the absolute values exceeds a corresponding threshold value, that is, at least one of the determinations in steps S210, S220, and S230 is negative, the travelling-condition determining subroutine proceeds to step S240. In step S240, the CPU 11 stores, in the memory unit 12, travelling-condition information representing that the current travelling condition of the vehicle V is a turning condition in which the vehicle V is turning. Thereafter, the CPU 11 terminates the travelling-condition determining subroutine, and carries out the next operation in step S130 of the assistance region setting routine illustrated in FIG. 2.

Otherwise, when all the absolute values are equal to or less than the respective threshold values, that is, all of the determinations in steps S210, S220, and S230 are affirmative, the travelling-condition determining subroutine proceeds to step S250.

In step S250, the CPU 11 calculates, based on the travelling condition signal sent from the steering-angle sensor, an absolute value of an angular velocity of the current driver's steering of the steering wheel. In step S250, the CPU 11 also calculates, based on at least one of one or more picked-up images sent from the camera 22, and map information received from a navigation system, the radius R of curvature on a current road on which the vehicle V is travelling at predetermined X meters ahead of the vehicle V.

Specifically, in step S250, the CPU 11 can calculate the rate of change of the driver's steering angle of the steering wheel as the angular velocity of the current driver's steering of the steering wheel. In step S250, the CPU 11 can recognize lane makers on the current road using one of knows lane-marker recognition technologies, and obtain the radius R of curvature on the current road at the predetermined X meters ahead of the vehicle V based on how a trajectory of the recognized lane markers is curved. In step S250, if the navigation system 28 is installed in the vehicle V, the CPU 11 can obtain, from the map information around the current position of the vehicle V received from the navigation system 28, the radius R of curvature on the current road at the predetermined X meters ahead of the vehicle V.

Then, the CPU 11 determines whether

(1) The absolute value of the angular velocity of the current driver's steering of the steering wheel is equal to or less than a predetermined fourth threshold value TD in step S250

(2) The radius R of curvature on the current road at the predetermined X meters ahead of the vehicle V is equal to or more than a predetermined fifth threshold value TE in step S260.

When the absolute value of the angular velocity of the current driver's steering of the steering wheel exceeds the fourth threshold value TD (NO in step S250), the travelling-condition determining subroutine proceeds to step S270. In addition, when the radius R of curvature on the current road at the predetermined X meters ahead of the vehicle V is less than the fifth threshold value TE (NO in step S260) although the determination in step S250 is affirmative (YES in step S250), the travelling-condition determining subroutine also proceeds to step S270.

In step S270, the CPU 11 stores, in the memory unit 12, travelling-condition information representing that the current travelling condition of the vehicle V is a predicted turning condition in which the vehicle V is predicted to be about to turn. Thereafter, the CPU 11 terminates the travelling-condition determining subroutine, and carries out the next operation in step S130 of the assistance region setting routine illustrated in FIG. 2.

Otherwise, when the absolute value of the angular velocity of the current driver's steering of the steering wheel is equal to or less than the fourth threshold value TD (YES in step S250), and the radius R of curvature on the current road at the predetermined X meters ahead of the vehicle V is equal to or more than the fifth threshold value TE (YES in step S260), the travelling-condition determining subroutine proceeds to step S280.

In step S280, the CPU 11 stores, in the memory unit 12, travelling-condition information representing that the current travelling condition of the vehicle V is a straight-ahead condition in which the vehicle V is travelling straight. Thereafter, the CPU 11 terminates the travelling-condition determining subroutine, and carries out the next operation in step S130 of the assistance region setting routine illustrated in FIG. 2.

After completion of the travelling-condition determining subroutine, in step S130, the CPU 11 reads the traveling-condition information stored in the memory unit 12, and determines, based on the travelling-condition information stored in the memory unit 12, whether the vehicle V is turning.

When it is determined that the vehicle V is turning (YES in step S130), the assistance region setting routine proceeds to step S150.

Otherwise, when it is determined that the vehicle V is not turning (NO in step S130), the CPU 11 determines, based on the travelling-condition information stored in the memory unit 12, whether the vehicle V is about to turn in step S140. When it is determined that the vehicle V is about to turn (YES in step S140), the assistance region setting routine proceeds to step S150.

In step S150, the CPU 11 serves as, for example, a first unit to estimate a turning course, i.e. a turning track, of the vehicle V. For example, the CPU 11 estimates a turning course of a predetermined point, for example, the center C of gravity of the vehicle V. In step S150, the CPU 11 also serves as, for example, the first unit to calculate a turning angle θ1 of the vehicle V, described in detail hereinafter, and obtains a driver's visual field θ3 and a view angle θ4 of the camera 22 described in detail hereinafter in step S160.

The turning angle θ1, the driver's visual field θ3, and the view angle θ4 of the camera 22 are defined as illustrated in FIG. 4.

Specifically, referring to FIG. 4, the turning angle θ1 of the vehicle V is defined as a turning angle of the vehicle V relative to the reference plane RP in the horizontal direction, i.e. the vehicle width direction. The left side of the turning angle θ1 relative to the reference plane RP is defined as a positive side, and the other side is defined as a negative side. How to obtain the turning angle θ1 of the vehicle V will be described later in step S150 of the assistance region setting routine.

The driver's visual field θ3 is previously determined as an angular range of the driver's view within which the driver can visibly recognize objects existing within the range in the vehicle width direction. As illustrated in FIG. 4, the driver's visual field θ3 has a center line set to be in agreement with a turned reference plane RPA of the vehicle V relative to the reference plane RP. In other words, the driver's visual field θ3 is defined based on the turning angle θ1 of the vehicle V relative to the reference plane RP in the vehicle width direction. Therefore, as illustrated in FIG. 4, when the turning angle θ1 of the vehicle V is changed in the left direction relative to the reference plane RP, the driver's visual field θ3 is changed in the left direction, so that the driver's sight is set to the inside of a turning course of the vehicle V.

The view angle θ4 of the camera 22 represents a predetermined angular width of the view angle of the camera 22 in the vehicle width direction, which represents the range of the imaging region IR of the camera 22 in the vehicle width direction. The view angle θ4 of the camera 22 has a center line set to be in agreement with the direction of the optical-axis adjustment angle θ2 relative to the reference plane RP in the vehicle width direction.

The predetermined magnitudes, i.e. values, of the driver's visual field θ3 and the view angle θ4 of the camera 22 are stored beforehand in the memory unit 12.

Specifically, the CPU 11 predicts a future position of the center C of gravity of the vehicle V T seconds later, which will be referred to as C(T), using the travelling condition signals sent from the various sensors 21, particularly, the vehicle speed sensor, the yaw-rate sensor, and/or the steering-angle sensor (see FIG. 5). For example, the CPU 11 increases the time T with decrease of the vehicle speed, but uses the time T having a constant value independently of the vehicle speed.

The CPU 11 estimates, based on the positional relationship between the future position C(T) of the center C of gravity of the vehicle V and the current position of the center C of gravity of the vehicle V, a turning course of the vehicle V including the direction of turning of the vehicle V in step S150. In addition, the CPU 11 obtains a line L connecting between the current position of the center C of gravity of the vehicle V and the future position C(T) of the center C of gravity of the vehicle V. Thus, the CPU 11 obtains, based on the line L, a minimum angle of the line L relative to the reference plane RP as the turning angle θ1 of the vehicle V in step S150.

Specifically, the turning angle θ1 of the vehicle V represents the amount of turning of vehicle V when it is determined that the vehicle V is turning or is about to turn.

Next, in step S160, the CPU 11 reads the magnitudes of the driver's visual field θ3 and the view angle θ4 of the camera 22 from the memory unit 12, and determines the position of the driver's visual field θ3 relative to the turning angle θ1, i.e. the turned reference plane RPA.

Following the operations in steps S150 and S160, the CPU 11 calculates the optical-axis adjustment angle 82 based on the turning angle θ1 of the vehicle V, the driver's visual field θ3, and the view angle θ4 of the camera 22 in step S170.

For example, the controller 10 according to the first embodiment has a map M in data-table or mathematical expression format stored in the memory unit 12 (see FIG. 1), and/or a program format coded in the assistance region setting routine. The map M includes information indicative of a relationship between the optical-axis adjustment angle 82, the turning angle θ1 of the vehicle V, the driver's visual field θ3, and the view angle 84 of the camera 22.

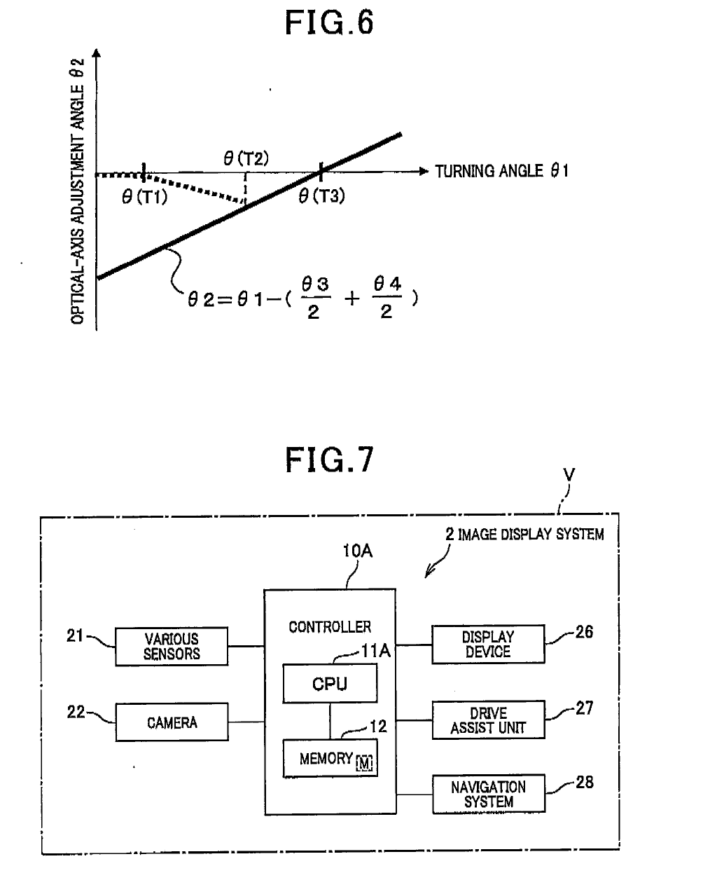

FIG. 6 schematically illustrates a graph indicative of how the optical-axis adjustment angle θ2 changes, which is represented as the vertical axis of the graph, as the turning angle θ1 of the vehicle V positively changes, which is represented as the horizontal axis of the graph, in accordance with the map M. That is, how the optical-axis adjustment angle θ2 changes as the turning angle θ1 of the vehicle V positively changes will be described hereinafter with reference to FIG. 6. Note that, about how the optical-axis adjustment angle θ2 changes as the turning angle θ1 of the vehicle V negatively changes, the following descriptions can be applied as long as

(1) The horizontal axis of FIG. 6 is replaced with an absolute value of the turning angle θ1 of the vehicle V

(2) The polarity of the optical-axis adjustment angle θ2 illustrated in FIG. 6 is reversed.

Specifically, the CPU 11 serves as, for example, a third unit to set the optical-axis adjustment angle θ2 to be zero while the turning angle θ1 of the vehicle V increases from zero up to a first threshold directed angle θ(T1) in step S170a (see FIG. 6). This prevents movement of the optical axis OA, i.e. the imaging region IR, of the camera 22 while the turning angle θ1 of the vehicle V increases from zero up to the first threshold directed angle θ(T1).

After the turning angle θ1 of the vehicle V exceeds the first threshold directed angle θ(T1), the CPU 11 reduces the optical-axis adjustment angle θ2 with an increase of the turning angle θ1 of the vehicle V until the turning angle θ1 of the vehicle V reaches a second threshold directed angle θ(T2) in step S170b (see FIG. 6).

In other words, after the turning angle θ1 of the vehicle V exceeds the first threshold angle θ(T1), the CPU 11 increases the absolute value of the optical-axis adjustment angle θ2 in the right direction of the vehicle V as the turning angle θ1 of the vehicle V increases in the left direction up to the second threshold directed angle θ(T2) in step S170b.

For example, a given monotonically decreasing function can be used for change of the optical-axis adjustment angle θ2 while the turning angle θ1 of the vehicle V increases from the first threshold directed angle θ(T1) up to the second threshold directed angle θ(T2). In other words, a given monotonically increasing function can be used for change of the absolute value of the optical while the turning angle θ1 of the vehicle V increases from the first threshold directed angle θ(T1) up to the second threshold directed angle θ(T2).

In addition, as illustrated in FIG. 6, a lower limit θ2ₗᵢₘᵢₜ for the optical-axis adjustment angle θ2 is determined based on the turning angle θ1 of the vehicle V, the driver's visual field θ3, and the view angle θ4 of the camera 22. For example, the lower limit θ2ₗᵢₘᵢₜ for the optical-axis adjustment angle θ2 is given as the following function expression [1]:

θ2ₗᵢₘᵢₜ=θ1−(θ3/2+θ4/2) [1]

That is, the equation means that change of the optical-axis adjustment angle θ2 in the right direction relative to the reference plane RP satisfies the condition that a driver's viewable range DVR defined based on the driver's visual field θ3 (see FIG. 4) and the imaging region IR defined based on the view angle θ4 of the camera 22 at least partly overlap with each other.

In other words, the CPU 11 changes the optical-axis adjustment angle θ2 in the right direction relative to the reference plane RP such that an overlap angular region between the driver's viewable range DVR and the imaging region IR is set to be equal to or greater than zero in step S170c (see FIG. 6).

That is, at least partial overlap between the driver's viewable range DVR and the imaging region IR includes a case where a first boundary of the driver's viewable range DVR closer to the reference plane RP than to the other second boundary is in agreement with a first boundary of the imaging region IR closer to the reference plane RP than to the other second boundary.

How to establish the equation [1] will be described hereinafter as follows:

As illustrated in FIG. 4, when the first boundary of the driver's viewable range DVR matches with the first boundary of the imaging region IR, the following equations should be satisfied between the driver's visual field θ3 and the view angle θ4 of the camera 22 when the optical-axis adjustment angle θ2 is set to an absolute value:

(θ1−θ3/2)=(θ4/2−θ2)

θ2=−θ1+(θ3/2+θ4/2) [A]

The equation [A] represents that, when the absolute value of the optical-axis adjustment angle θ2 is equal to or less than the value =−θ1+(θ3/2+θ4/2), a partial overlap between the driver's viewable range DVR and the imaging region IR can be established.

Consideration of the polarity of the optical-axis adjustment angle θ2, the following equation is established:

θ2=θ1−(θ3/2+θ4/2)

That is, as long as the optical-axis adjustment angle θ2 is equal to or greater than a lower limit θ2ₗᵢₘᵢₜ equal to “θ1−(θ3/2+θ4/2)”, a partial overlap between the driver's viewable range DVR and the imaging region IR can be established.

The lower limit θ2ₗᵢₘᵢₜ for the optical-axis adjustment angle θ2 can be given as the following function expression [2]:

θ2ₗᵢₘᵢₜ=θ1−(θ3/X+θ4/Y) [2]

where X≧2 and Y≧2

Setting a given value for each of the variables X and Y can adjust the overlap angular range between the driver's viewable range DVR and the imaging region IR. The CPU 11 can set a given value of each of the variables X and Y, but the driver of the vehicle V can enter a given value for each of the variables X and Y to the controller 10.

After the turning angle θ1 of the vehicle V exceeds the second threshold angle θ(T2), the optical-axis adjustment angle θ2 reverses to increase with an increase of the turning angle θ1 of the vehicle V, so that the orientation of the optical axis OA of the camera 22 becomes closer to the reference plane RP.

In other words, after the turning angle θ1 of the vehicle V exceeds the second threshold angle θ(T2), as the turning angle θ1 of the vehicle V increases in the left direction relative to the reference plane RP up to a third threshold angle θ(T3), the absolute value of the optical-axis adjustment angle θ2 in the right direction relative to the reference plane RP opposite to the left direction of the turning angle θ1 of the vehicle V decreases.

When the turning angle θ1 of the vehicle V reaches the third threshold angle θ(T3), the optical-axis adjustment angle θ2 becomes zero. Thereafter, as the turning angle θ1 of the vehicle V increases from the third threshold angle θ(T3), the optical-axis adjustment angle θ2 positively increases in the same left direction relative to the reference plane RP as the left direction of the turning angle θ1 of the vehicle V.

Specifically, in step S170, the CPU 11 serves as, for example, a second unit to extract a value of the optical-axis adjustment angle θ2 from the map M; the value of the optical-axis adjustment angle θ2 corresponds to a value of the turning angle θ1 of the vehicle V.

Then, the CPU 11 serves as, for example, the second unit to send an instruction to the camera driver 23; the instruction adjusts the optical-axis adjustment angle θ2 to the extracted value, thus adjusting the orientation of the optical axis OA relative to the reference plane RP in step S190. This determines the position of the view angle θ4 of the camera 22 relative to the adjusted optical axis OA. Thereafter, the CPU 11 terminates the assistance region setting routine.

On the other hand, when it is determined that the vehicle V is not about to turn (NO in step S140), the assistance region setting routine proceeds to step S180. In step S180, the CPU 11 sets the optical-axis adjustment angle θ2 to zero, terminating the assistance region setting routine.

As illustrated in FIG. 4, the imaging region IR of the camera 22 in the vehicle width direction is defined based on the determined position of the view angle θ4 of the camera 22 relative to the adjusted optical axis OA. For this reason, the drive assist unit 27 obtains images of the imaging region IR picked up by the camera 22, and performs, under control of the controller 10, the task for assisting drive of the vehicle V based on the picked-up images set forth above.

As described above, the controller 10 of the drive assist system 1 is configured to determine whether the vehicle V is travelling straight, is turning, or is about to turn (see step S130).

Then, the controller 10 is configured to obtain, based on at least one of the travelling-condition parameters, a turning parameter indicative of how the vehicle V is turning or is about to turn when it is determined that the vehicle V is turning or is about to turn; the turning parameter includes a turning course of the vehicle V.

Then, the controller 10 is configured to set the imaging region IR of the camera 22 to the outside of the turning course of the vehicle V (see FIG. 5). In other words, the controller 10 is configured to move the imaging region IR of the camera 22 from the front side of the vehicle V to the outside of the turning course of the vehicle V (see FIG. 5).

For example, the controller 10 is configured to change the optical axis OA of the camera 22 in the direction opposite to the direction of the turning course of the vehicle V.

That is, when the vehicle V is turning on, for example, a curved road, the driver of the vehicle V is likely watching the region located inside the turning course of the vehicle V, i.e. looking to the left if turning towards the left or the right if turning towards the right.

Therefore, if the imaging region IR of the camera 22 was unchanged when the vehicle V is turning, it might be difficult for the driver to recognize the circumstances of another region located outside the turning course of the vehicle V, for example, a region located towards the left if the vehicle is turning towards the right at a junction or on a curve or vice versa.

In contrast, the configuration of the drive assist system 1 makes it possible to complementarily pick up images of the region located outside the turning course of the vehicle V; the region is expected to be overlooked by the driver of the vehicle V. This makes it possible to provide, via the display device 26, the picked-up images to the driver of the vehicle V, thus enabling the driver of the vehicle V to easily recognize the circumstances of the region located outside the turning course of the vehicle V.

In addition, the controller 10 of the drive assist system 1 is configured to obtain, as the turning angle θ1, the amount of turning of the vehicle V when it is determined that the vehicle V is turning around or is about to turn.

Specifically, the controller 10 of the drive assist system 1 is configured to prevent setting, i.e. movement, of the imaging region IR to a region located outside the turning course of the vehicle V while the amount of turning of the vehicle V is smaller than a predetermined threshold amount, i.e. the first threshold directed angle θ(T1) (see step S170a in FIG. 2 and FIG. 6).

This configuration makes it possible to

(1) Complementarily pick up images of a region close to the driver's sight if the amount of turning of the vehicle V is smaller than the first threshold amount

(2) Complementarily pick up images of a region located to be separated from the driver's sight if the amount of turning of the vehicle V is equal to or greater than the first threshold amount.

The controller 10 of the drive assist system 1 is configured to

(1) Determine the position of the driver's visual field θ3 relative to the turning angle θ1 of the vehicle V (see step S160)

(2) Change the optical-axis adjustment angle θ2 in the direction opposite to the direction of the turning course of the vehicle V such that the overlap angular region between the driver's viewable range DVR and the imaging region IR is set to be equal to or greater than a target amount, such as zero (see step S170c and FIG. 6).

This configuration prevents a dead zone from occurring between the imaging region IR and the driver's viewable range DVR.

The controller 10 of the drive assist system 1 is configured to increase the amount of the movement of the imaging region IR to the outside of the turning course of the vehicle V as the amount of turning of the vehicle V increases (see step S170b). This results in the amount of the movement of the imaging region IR to the outside of the turning course of the vehicle V being suitable for the amount of turning of the vehicle V.

The controller 10 of the drive assist system 1 is configured to calculate, as the amount of the turning of the vehicle V, the turning angle θ1 of the vehicle V using at least one of the travelling-condition parameters including the steering angle of the steering wheel of the vehicle V, the yaw rate of the vehicle V, the acceleration of the vehicle V in the vehicle width direction, and the speed of the vehicle V. This configuration of the drive assist system 1 results in being simplified as compared with a configuration of another drive system using an additional device for calculating the amount of turning of the vehicle V. This is because this configuration of the current drive assist system 1 calculates the amount of turning of the vehicle V using the travelling-condition parameters that are detectable by existing vehicles.

In addition, the controller 10 of the drive assist system 1 is configured to

(1) Predict a future position of the center C of gravity of the vehicle V after the predetermined time T using the travelling condition signals sent from the various sensors 21

(2) Obtain the turning course of the vehicle V based on the positional relationship between the future position C(T) of the center C of gravity of the vehicle V and the current position of the center C of gravity of the vehicle V

(3) Obtain a line L connecting between the current position of the center C of gravity of the vehicle V and the future position C(T) of the center C of gravity of the vehicle V

(4) Obtain the turning angle θ1 of the vehicle V based on the line L (see step S150).

Specifically, drivers usually have tendency to change their lines of sight toward a future position of the vehicle V when the vehicle V is turning. Thus, this configuration makes it possible to obtain the turning course of the vehicle V matching with change of the driver's line of sight.

The controller 10 of the drive assist system 1 is configured to increase the time T required to predict the future position of the center C of gravity of the vehicle V with decrease of the speed of the vehicle V. If the time T is constant and the speed of a vehicle is relatively low, there may be tendency that the calculated amount of turning of the vehicle V becomes small relative to change of the driver's line of sight. In view of such a circumstance, this configuration increases the time T required to predict the future position of the center C of gravity of the vehicle V with decrease of the speed of the vehicle V, thus improving the tendency.

### Second Embodiment

A drive assist system 2 according to the second embodiment of the present disclosure will be described hereinafter with reference to FIGS. 7 to 9.

The structure and functions of the drive assist system 2 are slightly different from those of the drive assist system 1 by the following points. So, the different points will be mainly described hereinafter.

The drive assist system 2 is operative to set the image-processing region for each of the picked-up images to the outside of a turning course of the vehicle V.

Specifically, as illustrated in FIG. 7, the drive assist system 2 includes a controller 10A, the various sensors 21, the camera 22, the display device 26, and the drive assist unit 27. That is, the drive assist system 2 does not include the camera driver 23, but can include the camera driver 23.

A CPU 11A of the controller 10A performs various routines, i.e. various sets of instructions, including an assistance region setting routine, stored in the memory device 12; the assistance region setting routine is slightly different from the assistance region setting routine described in the first embodiment.

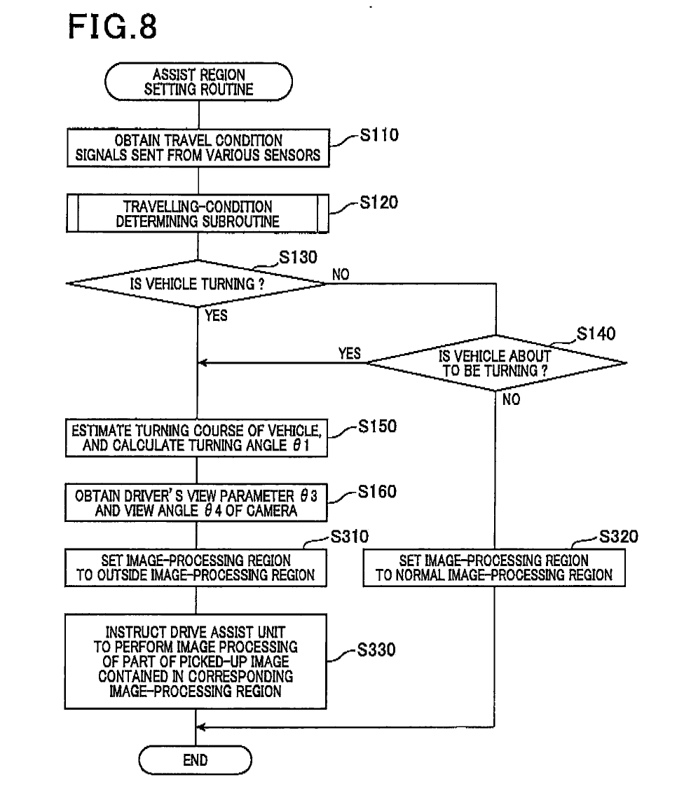

For example, when the vehicle V is powered on, i.e. the ignition of the vehicle V is switched on, the CPU 11A of the controller 10A starts the assistance region setting routine, and performs the assistance region setting routine every predetermined cycle (see FIG. 8).

As illustrated in FIG. 8, the CPU 11A performs the operations in steps S110 to S160 in the same procedure as those illustrated in FIG. 2. In addition, the CPU 11A performs new operations in steps S310 to S330 in place of the operations in steps S170 to S190 illustrated in FIG. 2.

Specifically, following the operations in steps S150 and S160, the CPU 11A sets the image-processing region for the picked-up images to an outside image-processing region in step S310. On the other hand, following the operation in step S140, the CPU 11A sets the image-processing region for the picked-up images to a normal image processing region in step S320. After completion of the operation in each of steps S310 and S320, the assistance region setting routine proceeds to step S330.

As described above, the image-processing region is defined as a region set in each of the picked-up images such that the drive assist unit 27 performs image processing, i.e. known object-recognition processing, of at least part of each of the picked-up images contained in the image-processing region.

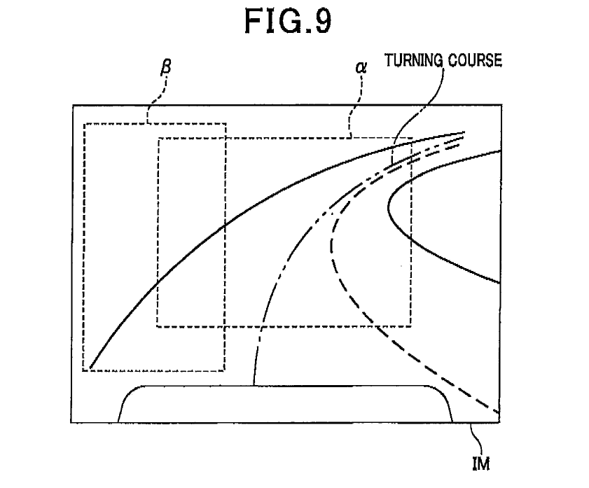

For example, FIG. 9 schematically illustrates a normal image-processing region α and an outside image-processing region β located on an image IM picked up by the camera 22 based on the imaging region IR assuming that the turning angle θ1 of the vehicle V is changed in the right direction relative to the reference plane RP.

As illustrated in FIG. 9, the normal image-processing region α is set on a substantially center portion of the picked-up image IM, and the outside image-processing region β is set to include a portion in the picked-up image IM; the portion matches with the outside of the turning course of the vehicle V. Note that the size of each of the normal image-processing region α and outside image-processing region β is previously set to be equal to or smaller than the frame size of each of the picked-up images.

In step S330, the CPU 11A instructs the drive assist unit 27 to concentratedly perform image processing, i.e. known object-recognition processing, of part of each of the picked-up images; the part of each of the picked-up images is contained in a corresponding one of the normal image-processing region α and outside image-processing region β. Thereafter, the CPU 11A terminates the assistance region setting routine.

Note that, in step S330, the CPU 11A can instruct the drive assist unit 27 to

(1) Perform image processing, i.e. known object-recognition processing, of part of each of the picked-up images with a higher priority; the part of each of the picked-up images is contained in a corresponding one of the normal image-processing region α and outside image-processing region β

(2) Perform image processing, i.e. known object-recognition processing, of the remaining part of each of the picked-up images with a lower priority; the remaining part of each of the picked-up images is uncontained in a corresponding one of the normal image-processing region α and outside image-processing region β.

Note that image processing of a part of a picked-up image with a higher priority means that

(1) The number of specific processes required to perform the image processing of the high priority part of the picked-up image is greater than that required to perform the image processing of the remaining part of the picked-up image

(2) The image processing of the high priority part of the picked-up image is faster than that of the remaining part of the picked-up image.

This results in an improvement of the image-processing accuracy for the part of the picked-up image as compared with that for the remaining part of the picked-up image while maintaining faster the image processing for the part of the picked-up image.

As described above, the drive assist system 2 is configured to perform image processing of a portion of a picked-up image; the portion matches with a region located outside the turning course of the vehicle V with a higher priority as compared with the remaining portion of the picked-up image, and the region is expected to be overlooked by the driver of the vehicle V. This makes it possible to immediately detect at least one obstacle, such as another vehicle and a pedestrian, in the portion of the picked-up image. This therefore makes it possible to perform at least one of

(1) The task for assisting drive of the vehicle V to avoid the detected at least one obstacle

(2) Visibly and/or audibly generating a warning of the detected at least one obstacle to the driver of the vehicle V.

The present disclosure is not limited to the descriptions of each of the rust and second embodiments, and the descriptions of each of the first and second embodiments can be widely modified within the scope of the present disclosure.

The drive assist system (1, 2) according to each of the first and second embodiments is configured to set, as the assistance region for assisting driver's recognition of the circumstances around the vehicle V, a corresponding one of the imaging region IM and the image-processing region to the outside of the turning course of the vehicle V. The present disclosure is however not limited to the configuration.

Specifically, the drive assist system (1, 2) according to each of the first and second embodiments can be configured to set, as the assistance region for assisting driver's recognition of the circumstances around the vehicle V, each of the imaging region IM and the image-processing region to the outside of the turning course of the vehicle V.

The drive assist system (1, 2) according to each of the first and second embodiments can be configured to simply obtain a directed turning angle θ1 of the vehicle V using at least one of the travelling condition signals sent from the various sensors 21. For example, the drive assist system (1, 2) according to each of the first and second embodiments can be configured to obtain a turning angle θ1 of the vehicle V using only the current driver's steering angle of the steering wheel. The drive assist system (1, 2) according to each of the first and second embodiments can be configured to simply set the optical-axis adjustment angle θ2 to be equal to the turning angle θ1 of the vehicle V; the direction of the optical-axis adjustment angle θ2 relative to the reference plane RP is opposite to the direction of the turning angle θ1 of the vehicle V relative to the reference plane RP.

The drive assist system (1, 2) according to each of the first and second embodiments is configured to determine the position of the driver's visual field θ3 relative to the turning angle θ1, i.e. the turned reference plane RPA, but the present disclosure is not limited thereto. Specifically, the drive assist system according to the present disclosure can be configured to detect the orientation of the driver's sight in the vehicle width direction, and estimate the driver's visual field θ3 around, for example, the center C of gravity of the vehicle V independently of the turning angle θ1. For example, the drive assist system according to the present disclosure can be configured to track the eye movement of the driver using one of the various sensors 21, and detect the orientation of the driver's line of sight in the vehicle width direction based on the results of the eye-movement tracking.

While the illustrative embodiments of the present disclosure have been described herein, the present disclosure is not limited to the embodiments described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. An apparatus for setting an assistance region for assisting a driver's recognition of a circumstance around a vehicle, the assistance region being indicative of at least one of: an imaging region of a device for picking up an image of the imaging region, and a particular image-processing region in the picked-up image, the apparatus comprising:
a memory device; and
a controller communicable to the memory device,
the controller being configured to:
estimate, based on a travelling condition of the vehicle, a turning parameter indicative of how the vehicle is turning or is about to turn, the turning parameter including a turning course of the vehicle; and
set the assistance region to an outside of the turning course of the vehicle.

2. The apparatus according to claim 1, wherein the turning parameter includes an amount of turning of the vehicle, and the controller is configured to:
change the assistance region to the outside of the turning course of the vehicle based on the amount of turning of the vehicle.

3. The apparatus according to claim 2, wherein the controller is configured to:
prevent setting of the assistance region to the outside of the turning course of the vehicle when the amount of turning of the vehicle is smaller than a predetermined threshold amount.

4. The apparatus according to claim 2, wherein the controller is configured to:
determine a position of a viewable range of a driver of the vehicle based on the amount of turning of the vehicle; and
change the assistance region such that
there is an overlap region between the driver's viewable range and the assistance region, and
the overlap region is set to be equal to or greater than a target amount.

5. The apparatus according to claim 2, wherein the controller is configured to:
increase an amount of change of the assistance region to the outside of the turning course of the vehicle with an increase of the amount of turning of the vehicle.

6. The apparatus according to claim 1, wherein the controller is configured to:
obtain the turning parameter based on at least one of parameters indicative of the travelling condition of the vehicle,
the parameters including a steering angle of a steering wheel of the vehicle, a yaw rate of the vehicle, an acceleration of the vehicle in a width direction of the vehicle, and a speed of the vehicle.

7. The apparatus according to claim 6, wherein the controller is configured to:
predict a future position of a predetermined point of the vehicle after a predetermined time using at least one of the parameters; and
obtain the turning course of the vehicle based on a positional relationship between a current position of the predetermined point of the vehicle and the future position of the predetermined point of the vehicle.

8. The apparatus according to claim 7, wherein the controller is configured to:
obtain a line connecting between the current position of the predetermined point of the vehicle and the future position of the predetermined point of the vehicle; and
obtain, as the amount of turning of the vehicle, a minimum angle of the line relative to a reference plane; the reference plane passing through a center of gravity of the vehicle, and extending both in a longitudinal direction of the vehicle while the vehicle is travelling straight and in a height direction of the vehicle.

9. The apparatus according to claim 8, wherein the controller is configured to increase the predetermined time with decrease of the speed of the vehicle.

10. The apparatus according to claim 1, wherein the controller is configured to set one of the imaging region and the image-processing region to the outside of the turning course of the vehicle as the assistance region.

11. A computer program product for an apparatus that sets an assistance region for assisting a driver's recognition of a circumstance around a vehicle, the assistance region being indicative of at least one of an imaging region of a device for picking up an image of the imaging region, and a particular image-processing region in the picked-up image, the computer program product comprising:
a non-transitory computer-readable storage medium; and
a set of computer program instructions embedded in the computer-readable storage medium, the instructions causing a computer to carry out:
a first step of estimating, based on a travelling condition of the vehicle, a turning parameter indicative of how the vehicle is turning or is about to turn, the turning parameter including a turning course of the vehicle; and
a second step of setting the assistance region to an outside of the turning course of the vehicle.

12. The computer program product according to claim 11, wherein the turning parameter includes an amount of turning of the vehicle, and the second step is configured to:
change the assistance region to the outside of the turning course of the vehicle based on the amount of turning of the vehicle.

13. The computer program product according to claim 12, wherein the instructions causing a computer to carry out:
a third step of preventing setting of the assistance region to the outside of the turning course of the vehicle when the amount of turning of the vehicle is smaller than a predetermined threshold amount.

14. The computer program product according to claim 12, the second step is configured to:
determine a position of a viewable range of a driver of the vehicle based on the amount of turning of the vehicle; and
change the assistance region such that
there is an overlap region between the driver's viewable range and the assistance region, and
the overlap region is set to be equal to or greater than a target amount.

15. The computer program product according to claim 12, wherein the second step is configured to:
increase an amount of change of the assistance region to the outside of the turning course of the vehicle with an increase of the amount of turning of the vehicle.

16. The computer program product according to claim 11, wherein the instructions cause a computer to carry out:
a fourth step of obtaining the turning parameter based on at least one of parameters indicative of the travelling condition of the vehicle,
the parameters including a steering angle of a steering wheel of the vehicle, a yaw rate of the vehicle, an acceleration of the vehicle in a width direction of the vehicle, and a speed of the vehicle.

17. The computer program product according to claim 16, wherein the fourth step is configured to:
predict a future position of a predetermined point of the vehicle after a predetermined time using at least one of the parameters; and
obtain the turning course of the vehicle based on a positional relationship between a current position of the predetermined point of the vehicle and the future position of the predetermined point of the vehicle.

18. The computer program product according to claim 17, wherein the fourth step is configured to:
obtain a line connecting between the current position of the predetermined point of the vehicle and the future position of the predetermined point of the vehicle; and
obtain, as the amount of turning of the vehicle, a minimum angle of the line relative to a reference plane; the reference plane passing through a center of gravity of the vehicle, and extending both in a longitudinal direction of the vehicle while the vehicle is travelling straight and in a height direction of the vehicle.

19. The computer program product according to claim 18, wherein the fourth step is configured to:
increase the predetermined time with decrease of the speed of the vehicle.

20. The computer program product according to claim 11, wherein the second step is configured to:
set one of the imaging region and the image-processing region to the outside of the turning course of the vehicle as the assistance region.
